(19) United States
(12) Patent Application Publication
(10) Pub. No.: US 2024/0356238 A1
(43) Pub. Date: Oct. 24, 2024

(54) ANTENNA STRUCTURE

(71) Applicant: AUDEN TECHNO CORP., Taoyuan City (TW)

(72) Inventor: CHI-MING CHIANG, Taoyuan City (TW)

(21) Appl. No.: 18/137,528

(22) Filed: Apr. 21, 2023

(51) Int. Cl. H01Q 21/24; H01Q 21/00

(52) U.S. Cl. CPC H01Q 21/24; H01Q 21/0006

(57) ABSTRACT

An antenna structure includes four antenna arrays spaced apart from each other. Each of the four antenna arrays has four antennas. A first phase difference between any two adjacent ones of the four antennas is 90 degrees, so that the four antennas can jointly generate a first circular polarization. The four antenna arrays have a common center point, one of the four antennas of each of the four antenna arrays adjacent to the common center point is defined as a shared antenna, and the four shared antennas jointly form a shared antenna array. A second phase difference between any two adjacent ones of the four shared antennas is 90 degrees, so that the four shared antennas can jointly generate a second circular polarization that has a same rotation direction as the first circular polarization.

### FIELD OF THE DISCLOSURE

The present disclosure relates to a structure, and more particularly to an antenna structure.

### BACKGROUND OF THE DISCLOSURE

A conventional antenna structure has a plurality of antennas that are each connected by two phase shifters, and the two phase shifters input 90-degree phase difference signals in a horizontal direction and a vertical direction of one of the antennas, so that each of the antennas can independently generate a circular polarization. In other words, the conventional antenna structure is based on the architecture of “each of the antennas independently generating a circular polarization,” so the conventional antenna structure requires a large quantity of phase shifters (e.g., when the antennas of the conventional antenna structure are arranged in a 32 by 32 array, the conventional antenna structure requires 2048 phase shifters). However, the phase shifter is a high cost component, so that the cost of the conventional antenna structure remains high.

### SUMMARY OF THE DISCLOSURE

In response to the above-referenced technical inadequacy, the present disclosure provides an antenna structure.

In one aspect, the present disclosure provides an antenna structure. The antenna structure includes a substrate and four antenna arrays. The four antenna arrays are disposed on the substrate and are spaced apart from each other. Each of the four antenna arrays includes four antennas. A first phase difference between any two adjacent ones of the four antennas is 90 degrees, so that the four antennas are configured to jointly generate a first circular polarization. The four antenna arrays have a common center point, one of the four antennas of each of the four antenna arrays adjacent to the common center point is defined as a shared antenna, and the four shared antennas jointly form a shared antenna array. A second phase difference between any two adjacent ones of the four shared antennas is 90 degrees, so that the four shared antennas are configured to jointly generate a second circular polarization that has a same rotation direction as the first circular polarization.

Therefore, in the antenna structure provided by the present disclosure, by virtue of “a first phase difference between any two adjacent ones of the four antennas in each of the four antenna arrays being 90 degrees, so that the four antennas are configured to jointly generate a first circular polarization,” and “a second phase difference between any two adjacent ones of the four shared antennas being 90 degrees, so that the four shared antennas are configured to jointly generate a second circular polarization that has the same rotation direction as the first circular polarization,” the antenna structure can effectively reduce a quantity of phase shifters used therein, thereby reducing costs.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic perspective view of an antenna structure according to the present disclosure;

FIG. 2 is another schematic perspective view of the antenna structure according to the present disclosure;

FIG. 3 is a schematic planar view of the antenna structure according to the present disclosure;

FIG. 4 is a schematic partially planar view of the antenna structure according to the present disclosure;

FIG. 5 is another schematic partially planar view of the antenna structure according to the present disclosure;

FIG. 6 is a schematic view of a radiation pattern generated by an antenna array according to the present disclosure;

FIG. 7 is a schematic planar view of the antenna structure according to the present disclosure in another implementation;

FIG. 8 is a schematic view of a radiation pattern generated by the antenna structure according to the present disclosure in the another implementation;

FIG. 9 is a schematic view of a radiation pattern generated by the antenna structure according to the present disclosure in yet another implementation; and

FIG. 10 is a schematic view of a radiation pattern generated when a phase difference between the antenna array and a shared antenna array being 45 degrees according to the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

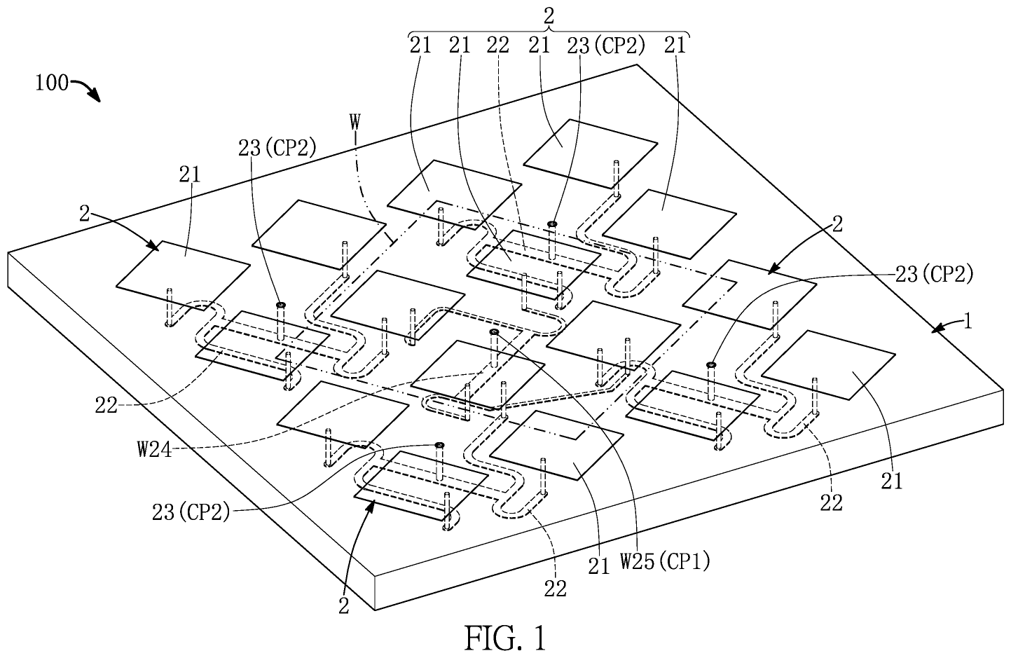

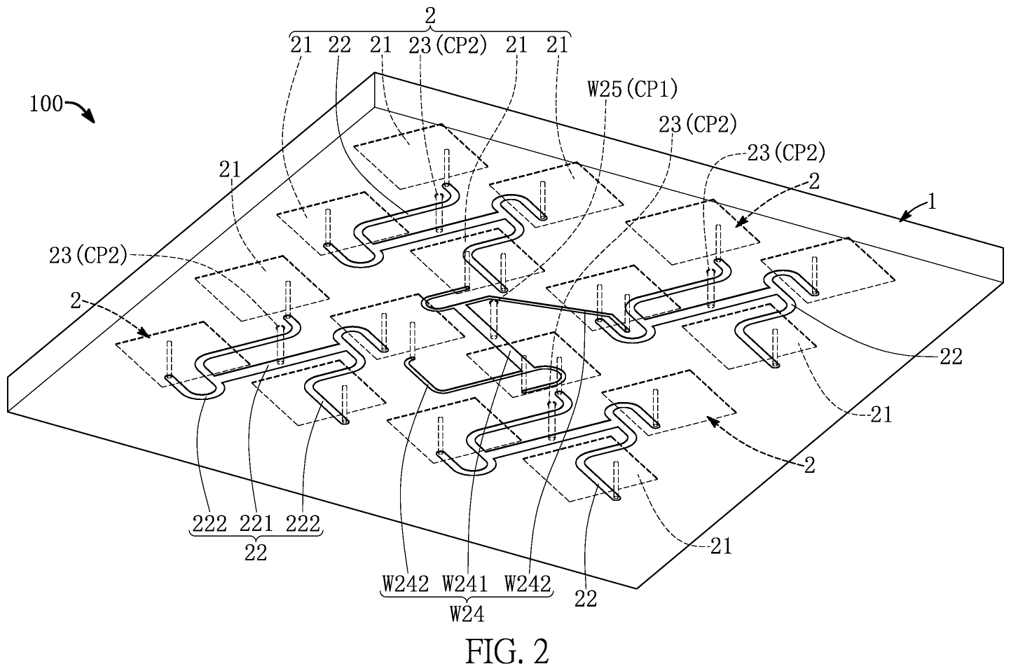

Referring to FIG. 1 to FIG. 10, the present disclosure provides an antenna structure 100 that is configured to be operated in a transmission frequency band. As shown in FIG. 1 and FIG. 2, the antenna structure 100 includes a substrate 1 and four antenna arrays 2 that are disposed on the substrate 1 and are arranged adjacent to each other. Each of the four antenna arrays 2 can produce a first circular polarization, and the four antenna arrays 2 can jointly produce a second circular polarization that has the same rotation direction as the first circular polarization, so that a quantity of phase shifters as required by the antenna structure 100 is much smaller than that of a conventional antenna structure, and a gain value finally generated by the antenna structure 100 is greater than or equal to that of the conventional antenna structure. The following description describes the structure and connection relation of each component of the antenna structure 100.

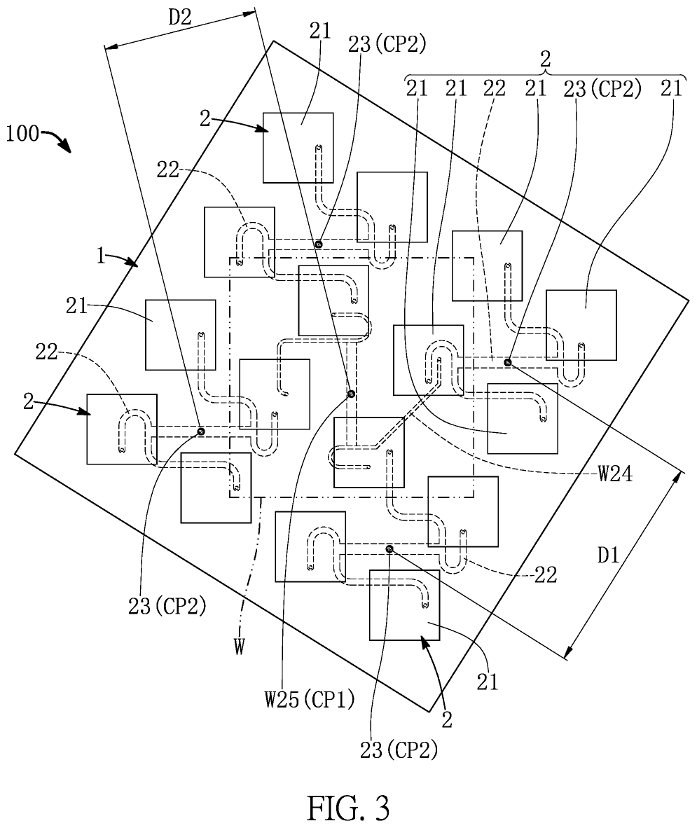

Referring to FIG. 1 and FIG. 3, the four antenna arrays 2 are arranged in a 2 by 2 matrix, and the four antenna arrays 2 have a common center point CP1. Each of the four antenna arrays 2 includes four antennas 21. The four antennas 21 are arranged in a 2 by 2 matrix, and have a sub-center point. In other words, the antenna structure 100 has sixteen antennas 21 arranged in a 4 by 4 matrix.

It should be noted that, in the present embodiment, a first separation distance D1 is between two sub-center points CP2 of any two adjacent ones of the four antenna arrays 2, and the first separation distance D1 is equal to 0.5 times the wavelength corresponding to the center frequency of the transmission frequency band. Moreover, a second separation distance D2 is between the sub-central point CP2 in each of the four antenna arrays 2 and the common central point CP1, and the first separation distance D1 is preferably equal to the second separation distance D2, but the present distance is not limited thereto. In general, the first separation distance D1 is preferably less than or equal to 10% of the second separation distance D2.

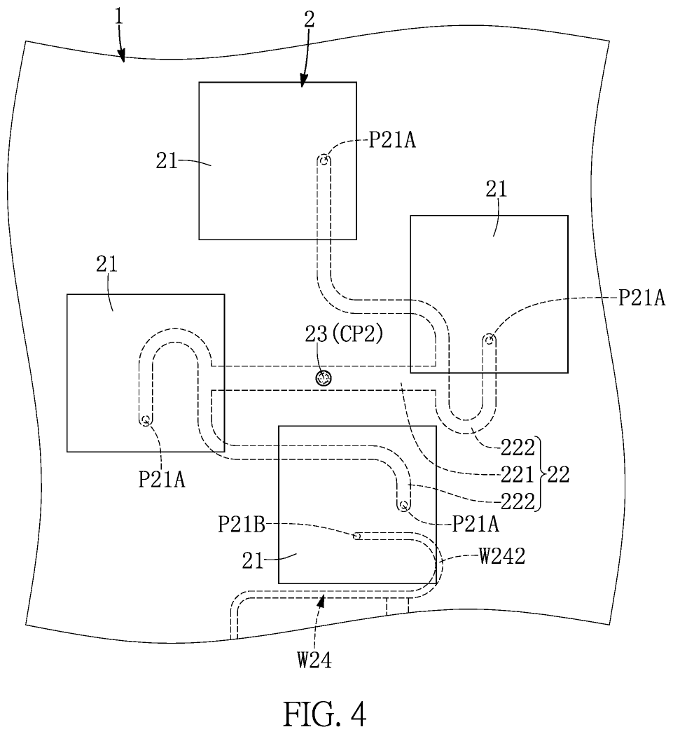

Referring to FIG. 3 and FIG. 4, in each of the four antenna arrays 2, a first phase difference between any two adjacent ones of the four antennas 21 is 90 degrees, so that the four antennas 21 are configured to jointly generate a first circular polarization by the first phase difference.

In a practical application, each of the four antenna arrays 2 further includes a first microstrip line 22 and a first phase shifter 23. The first microstrip line 22 is connected to a first feeding point P21A of each of the four antennas 21 (by an electrically conductive post), the first phase shifter 23 is connected (e.g., by welding) to the first microstrip line 22, and a first connection point is between the first phase shifter 23 and the first microstrip line 22. Preferably, a position of the first connection point overlaps the sub-central point CP2, but the present disclosure is not limited thereto (e.g., the first connection point is located on one side of the sub-central point CP2).

The first microstrip line 22 has a first shortest path from the first connection point to two first feeding points P21A of two of the four antennas 21 in one of the four antenna arrays 2, and the first microstrip line 22 has a second shortest path from the first connection point to two first feeding points P21A of another two of the four antennas 21 in one of the four antenna arrays 2. A first difference is between the first shortest path and the second shortest path, and the first phase shifter 23 generates the first phase difference by the first difference. Accordingly, each of the four antenna arrays 2 can generate the first circular polarization through the first microstrip line 22 and the first phase shifter 23.

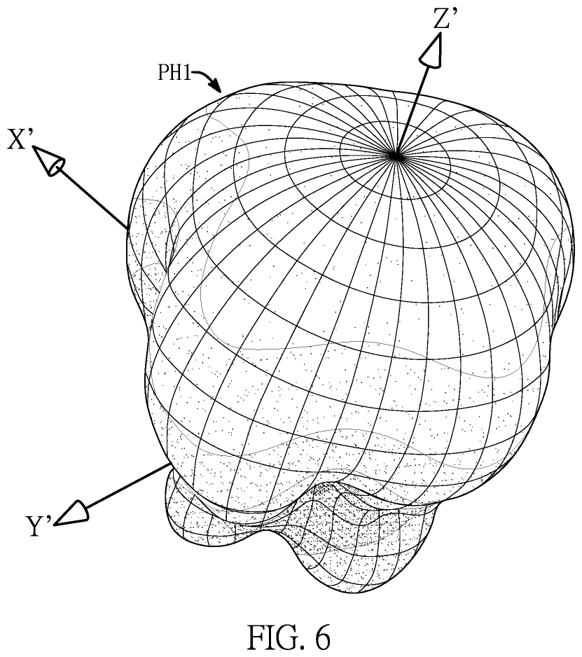

In more detail, the first microstrip line 22 has a first body segment 221 and two first connection segments 222. The first body segment 221 is connected to the first phase shifter 23, the two first connection segments 222 are respectively connected to two ends of the first body segment 221, and a width of the first body segment 221 is greater than a width of each of the two first connection segments 222. In addition, one part of each of the two first connection segments 222 is preferably designed to be substantially U-shaped, and another part of each of the two first connection segments 222 is designed to be substantially L-shaped (or V-shaped). Accordingly, the first microstrip line 22 can generate the first difference when the antenna structure 100 has a minimal area, but the present disclosure is not limited thereto. FIG. 6 is a schematic view of a radiation pattern PHI generated by one of the antenna arrays 2 according to the present disclosure.

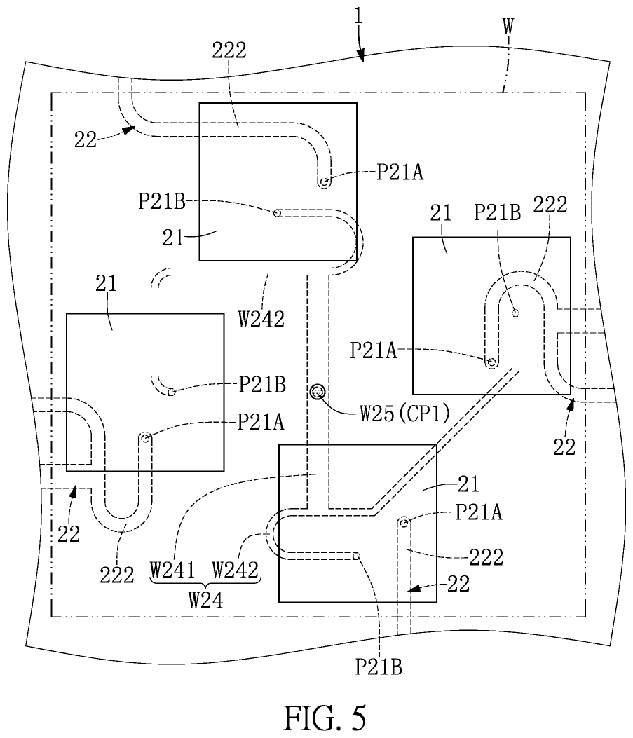

Referring to FIG. 3 and FIG. 5, one of the four antennas 21 of each of the four antenna arrays 2 adjacent to the common center point CP1 can be defined as a shared antenna, and the four shared antennas jointly form a shared antenna array W. A second phase difference between any two adjacent ones of the four shared antennas is 90 degrees, so that the four shared antennas are configured to jointly generate a second circular polarization that has the same rotation direction as the first circular polarization. In practice, in addition to having the first feeding point P21A, each of the four antennas 21 defined as one of the four shared antennas has a second feeding point P21B, and a phase difference between the first feeding point P21A and the second feeding point P21B is 90 degrees, so that the shared antenna array W is configured to generate the second circular polarization.

It should be noted that, in the present disclosure, a rotation direction of the second circular polarization needs to be consistent with a rotation direction of the first circular polarization (e.g., when the second circular polarization is left-handed, the first circular polarization of each of the four antenna arrays 2 is also left-handed), so as to avoid negative effects caused by mutual influence of signals (e.g., the buff value is weakened).

In a practical application, the shared antenna array W further includes a second microstrip line W24 and a second phase shifter W25. The second microstrip line W24 is connected to the second feeding point P21B of each of the four shared antennas (by an electrically conductive post), the second phase shifter W25 is connected (e.g., by welding) to the second microstrip line W24, and a second connection point is between the second phase shifter W25 and the second microstrip line W24. Preferably, a position of the second connection point overlaps the common center point CP1, but the present disclosure is not limited thereto (e.g., the second connection point is located on one side of the common center point CP1).

The second microstrip line W24 has a third shortest path from the second connection point to two second feeding points P21B of two of the four shared antennas, and the second microstrip line W24 has a fourth shortest path from the second connection point to two second feeding points P21B of another two of the four shared antennas. A second difference is between the third shortest path and the fourth shortest path, and the second phase shifter W25 generates the second phase difference by the second difference. Accordingly, the shared antenna array W can generate the second circular polarization through the second microstrip line W24 and the second phase shifter W25.

In more detail, the second microstrip line W24 has a second body segment W241 and two second connection segments W242. The second body segment W241 is connected to the second phase shifter W25, the two second connection segments W242 are respectively connected to two ends of the second body segment W241, and a width of the second body segment W241 is greater than a width of each of the two second connection segments W242. In addition, one part of each of the two second connection segments W242 is preferably designed to be substantially U-shaped, and another part of each of the two second connection segments W242 is designed to be substantially L-shaped (or V-shaped). Accordingly, the second microstrip line W24 can generate the second difference under architecture of the antenna structure 100 with the smallest area, but the present disclosure is not limited thereto.

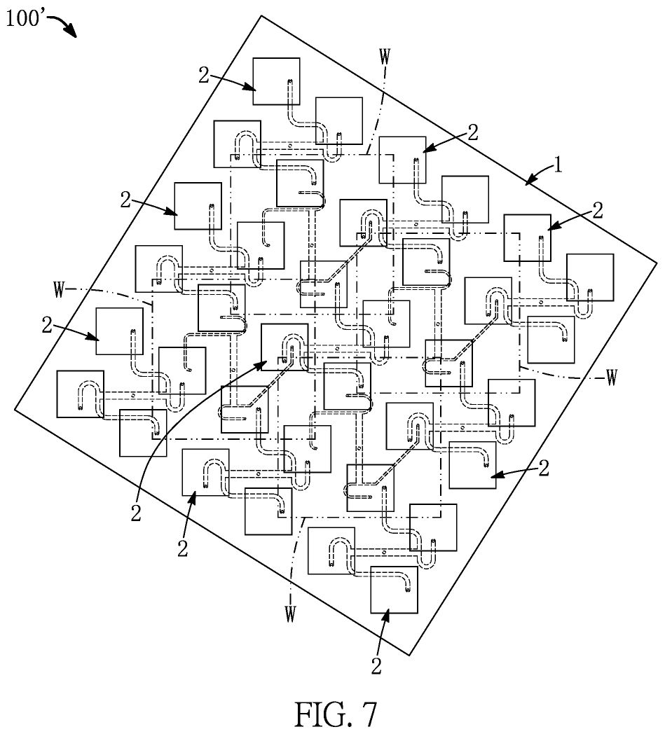

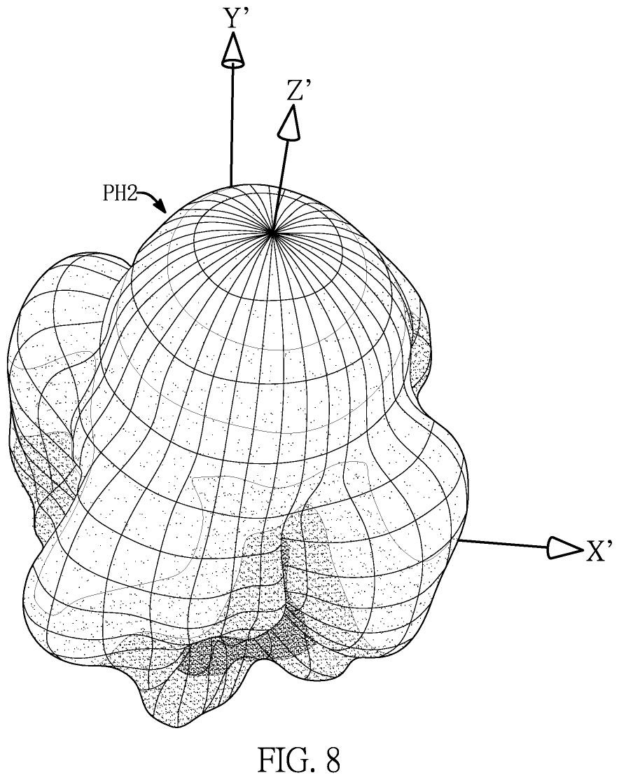

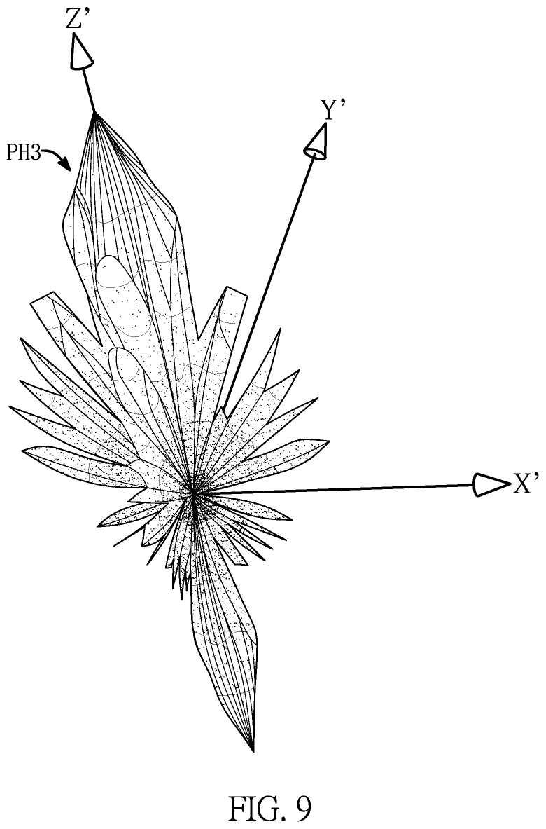

It should be noted that the antenna structure 100 in the present embodiment is described as including the four antenna arrays 2, but the present disclosure is not limited thereto. Specifically, the quantity of antenna arrays of the antenna structure can satisfy any M by N matrix arrangement (M and N are positive integers that are greater than or equal to 2). For example, in another embodiment of the present disclosure (not shown in the figures), the antenna structure 100 can also be adjusted to have six antenna arrays (e.g., in a 3 by 2 matrix arrangement), nine antenna arrays (e.g., in a 3 by 3 matrix arrangement), or ten antenna arrays (e.g., in a 5 by 2 matrix arrangement). For example, as shown in FIG. 7 and FIG. 8, the nine antenna arrays 2 of an antenna structure 100′ are arranged in a matrix of 3 by 3, and can generate a radiation pattern PH2 as shown in FIG. 8. In another example, as shown in FIG. 9, when a plurality of antenna arrays 2 are arranged in a matrix of 16 by 16, the antenna structure can generate a radiation pattern PH3 as shown in FIG. 9.

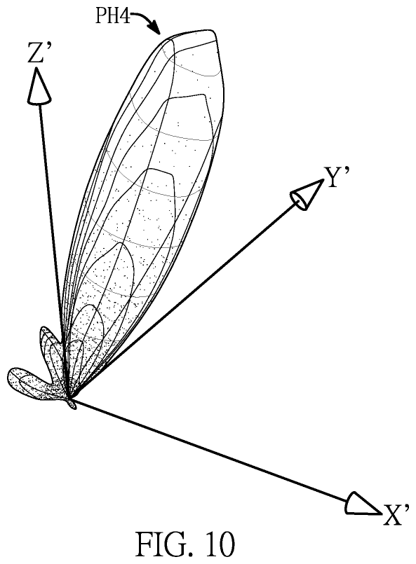

It is worth mentioning that a phase difference between the shared antenna array W and each of the four antenna arrays 2 can be designed to be 45 degrees. For example, when a phase of the shared antenna array W is “1 W, 90°,” a phase of each of the four antenna arrays 2 may be “1 W, 0°,” or “1 W, 90°”. Or, when a phase of the shared antenna array W is “1 W, 135°,” a phase of each of the four antenna arrays 2 may be “1 W, 90°,” or “1 W, 180°”. Accordingly, the antenna structure 100 can achieve an ideal beamforming effect. For example, as shown in FIG. 7 and FIG. 10, when the nine antenna arrays 2 of the antenna structure 100′ are arranged in a matrix of 3 by 3 and a phase difference between the shared antenna array W and each of the four antenna arrays 2 is designed to be 45 degrees, the antenna structure 100′ can generate a radiation pattern PH4 as shown in FIG. 10.

In addition, comparing with the conventional antenna structure, the antenna structure 100 in the present embodiment can save 75% of a quantity of phase shifters. For example, when a quantity of antennas used is 1024, a quantity of phase shifters in the antenna structure 100 of the present disclosure is 481, and a quantity of phase shifters in the conventional antenna structure is 2048. In other words, the antenna structure 100 can save about 75% of the quantity of phase shifters.

Based on the abovementioned disclosure, the antenna structure 100 can also be adjusted appropriately. For example, in another embodiment of the present disclosure (not shown in the figures), each of the antenna arrays 2 can have four first phase shifters 23 and a first connection line. The four first phase shifters 23 are respectively connected to the first feeding points P21A of the four antennas 21, and each of the four first phase shifters 23 can send first feed signals that have different phases to the four antennas 21 through the first feeding points P21A. The first connection line is electrically coupled to the four first phase shifters 23, and lengths of any part of the first connection line from the sub-central point CP2 to any one of the first feeding points P21A are equal (e.g., the first connection line is H-shaped). The four antennas 21 can generate the first circular polarization by different phases of the four first feed signals.

In addition, the shared antenna array W can have four second phase shifters W25 and a second connection line. The four second phase shifters W25 are respectively connected to the second feeding points P21B of the four shared antennas, and each of the four second phase shifters W25 can send second feed signals that have different phases to the four shared antennas through the second feeding points P21B. The second connection line is electrically coupled to the four second phase shifters W25, and lengths of any part of the second connection line from the common center point CPI to any one of the second feeding points P21B are equal (e.g., the second connection line is H-shaped). The four shared antennas can generate the second circular polarization by different phases of the four second feed signals.

### Beneficial Effects of the Embodiment

In conclusion, in the antenna structure provided by the present disclosure, by virtue of “a first phase difference between any two adjacent ones of the four antennas in each of the four antenna arrays being 90 degrees, so that the four antennas are configured to jointly generate a first circular polarization,” and “a second phase difference between any two adjacent ones of the four shared antennas being 90 degrees, so that the four shared antennas are configured to jointly generate a second circular polarization that has the same rotation direction as the first circular polarization,” the antenna structure can effectively reduce a quantity of phase shifters used therein, thereby reducing costs.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An antenna structure, comprising:
a substrate; and
four antenna arrays disposed on the substrate and being spaced apart from each other, wherein each of the four antenna arrays includes:
four antennas, wherein a first phase difference between any two adjacent ones of the four antennas is 90 degrees, so that the four antennas are configured to jointly generate a first circular polarization;
wherein the four antenna arrays have a common center point, one of the four antennas of each of the four antenna arrays adjacent to the common center point is defined as a shared antenna, and the four shared antennas jointly form a shared antenna array, and wherein a second phase difference between any two adjacent ones of the four shared antennas is 90 degrees, so that the four shared antennas are configured to jointly generate a second circular polarization that has a same rotation direction as the first circular polarization.

2. The antenna structure according to claim 1, wherein, in each of the four antenna arrays, the four antennas have a sub-center point; wherein two sub-center points of any two adjacent ones of the four antenna arrays have a first separation distance therebetween, the common central point and the sub-central point of any one of the four antenna arrays have a second separation distance therebetween, and the first separation distance is less than or equal to 10% of the second separation distance.

3. The antenna structure according to claim 2, wherein the first separation distance is equal to 10% of the second separation distance.

4. The antenna structure according to claim 2, wherein the antenna structure is configured to be operated in a transmission frequency band, and the first separation distance is equal to 0.5 times a wavelength corresponding to a center frequency of the transmission frequency band.

5. The antenna structure according to claim 1, wherein each of the four antennas of each of the four antenna arrays has a first feeding point, and each of the four antenna arrays further includes:
a first microstrip line connected to the first feeding point of each of the four antennas; and
a first phase shifter connected to the first microstrip line, wherein the first phase shifter and the first microstrip line have a first connection point therebetween;
wherein the first microstrip line has a first shortest path from the first connection point to two first feeding points of two of the four antennas in one of the four antenna arrays, and the first microstrip line has a second shortest path from the first connection point to two first feeding points of another two of the four antennas in one of the four antenna arrays, and wherein the first shortest path and the second shortest path have a first difference therebetween, and the first phase shifter generates the first phase difference by the first difference.

6. The antenna structure according to claim 5, wherein each of the four antennas defined as one of the four shared antennas has a second feeding point, and a phase difference between the first feeding point and the second feeding point is 90 degrees.

7. The antenna structure according to claim 6, wherein each of the four shared antennas includes:
a second microstrip line connected to the second feeding point of each of the four shared antennas; and
a second phase shifter connected to the second microstrip line, wherein the second phase shifter and the second microstrip line have a second connection point therebetween;
wherein the second microstrip line has a third shortest path from the second connection point to two second feeding points of two of the four shared antennas, and the second microstrip line has a fourth shortest path from the second connection point to two second feeding points of another two of the four shared antennas, and wherein the third shortest path and the fourth shortest path have a second difference therebetween, and the second phase shifter generates the second phase difference by the second difference.

8. The antenna structure according to claim 1, wherein a phase difference between the shared antenna array and each of the four antenna arrays is 45 degrees.

9. The antenna structure according to claim 1, wherein each of the four antennas of each of the four antenna arrays has a first feeding point, and each of the four antenna arrays further includes:
four first phase shifters respectively connected to the plurality of first feeding points of the four antennas, wherein the four first phase shifters are configured to send first feed signals that have different phases to the four antennas through the first feeding points; and
a first connection line electrically coupled to the four first phase shifters;
wherein the four antennas are configured to generate the first circular polarization by the first feed signals that have the different phases.

10. The antenna structure according to claim 9, wherein each of the four shared antennas of the shared antenna array has a second feeding point, and the shared antenna array includes:
four second phase shifters respectively connected to the plurality of second feeding points of the four shared antennas, wherein the four second phase shifters are configured to respectively send second feed signals that have different phases to the four shared antennas through the second feeding points; and
a second connection line electrically coupled to the four second phase shifters;
wherein the four shared antennas are configured to generate the second circular polarization by the second feed signals that have the different phases.
